(19) United States
(12) Patent Application Publication
(10) Pub. No.: US 2025/0267331 A1
(43) Pub. Date: Aug. 21, 2025

(54) OVERLAYING CONTENT AUGMENTING VIDEO DATA FROM A CONTENT PROVIDER SYSTEM DISPLAYED BY A CLIENT DEVICE

(71) Applicant: SUPER STREAMING TECH INC., Dallas, TX (US)

(72) Inventor: Bart Barden, Dublin (IE)

(21) Appl. No.: 19/054,751

(22) Filed: Feb. 14, 2025

Related U.S. Application Data
(60) Provisional application No. 63/670,101, filed on Jul. 11, 2024.
(60) Provisional application No. 63/553,762, filed on Feb. 15, 2024.

(51) Int. Cl. H04N 21/431; H04N 21/4402; H04N 21/658

(52) U.S. Cl. CPC H04N 21/4316; H04N 21/440263; H04N 21/6581

(57) ABSTRACT

A client device execute a browser that obtains a web page including video data. The browser includes an overlay extension that captures interactions with the browser. In response to detecting video data within the web page, the overlay extension transmits metadata identifying the detected video data to an overlay server. Subsequently, the overlay extension receives overlay content selected by the overlay server based on the metadata and renders the overlay content in a video player of the browser rendering the video data. The overlay extension accounts for one or more settings of the video player when rendering the overlay content in conjunction with the video data.

### CROSS REFERENCE TO RELATED APPLICATION

This application claims the benefit of U.S. Provisional Application No. 63/553,762, filed Feb. 15, 2024, and of U.S. Provisional Application No. 63/670, 101, filed Jul. 11, 2024, each of which is incorporated by reference in its entirety.

### BACKGROUND

### Technical Field

The described embodiments relate to a client device configured display video content received from a content provider system and to overlay content from a different system over one or more portions of the video content.

### Related Art

Various client devices, such as desktop computers, laptop computers, or mobile devices, obtain video data from one or more content provider systems and display the video data to users. The client device renders the video data to a user of the client device. For example, a client device obtains a web page from a content provider system including video data and renders the video data to the user. A content provider system may provide video data of live events, such as competitions, activities, presentations, or other events to a client device for presentation.

A content provider system may provide overlay content to a client device in addition to video data, and the client device presents the overlay content in conjunction with the video data. Such overlay content may be images, text, or other types of content that are presented in conjunction with the video data. Overlay content may be presented over one or more portions of the video data or may be presented in a web page in which the video data is presented. However, different content provider systems may differently regulate or limit overlay content that can be provided along with video data. Further, different overlay content may be relevant to different users to whom video data from a content provider system is presented, while various conventional content provider systems provide common overlay content to each user to whom a content provider system presents video data. Conventional content provider systems are also limited to providing overlay content in conjunction with video data to content that is accessible to the content provider system, limiting available content that may be presented in conjunction with video data to users.

### BRIEF DESCRIPTION OF THE DRAWINGS

FIG. 1 illustrates an example system environment for an overlay extension in a browser executing on a client device to overlay content on content the browser receives from a content provider system, in accordance with one or more embodiments.

FIG. 2 illustrates an example client device executing a browser including an overlay extension to overlay content on content the browser receives from a content provider system, in accordance with one or more embodiments.

FIG. 3 illustrates a flowchart of a method for a client device rendering overlay content on video data from a content provider system presented by the client device, in accordance with one or more embodiments.

FIG. 4 illustrates an example interface including overlay content rendered over video data in a video player of a browser, in accordance with one or more embodiments.

FIG. 5 illustrates an additional example interface including overlay content rendered over video data in a video player of a browser, in accordance with one or more embodiments.

FIG. 6 illustrates an additional example interface including overlay content rendered over video data in a video player of a browser, in accordance with one or more embodiments.

FIG. 7 illustrates an additional example interface including overlay content rendered over video data in a video player of a browser, in accordance with one or more embodiments.

FIG. 8 illustrates examples of overlay content for a chaser game that may be overlaid on video data by an overlay extension, in accordance with one or more embodiments.

FIG. 9 illustrates an additional example interface including overlay content rendered over video data in a video player of a browser, in accordance with one or more embodiments.

FIG. 10 is an example of an order summary capable of being presented as overlay content by the overlay extension, in accordance with one or more embodiments.

FIG. 11 illustrates an additional example interface including overlay content rendered over video data in a video player of a browser, in accordance with one or more embodiments.

FIG. 12 illustrates an additional example interface including overlay content rendered over video data in a video player of a browser, in accordance with one or more embodiments.

FIG. 13 illustrates an additional example interface including overlay content rendered over video data in a video player of a browser, in accordance with one or more embodiments.

### DETAILED DESCRIPTION

In various embodiments disclosed herein, a client device executes a browser that obtains a web page including video data. The browser includes an overlay extension that captures interactions with the browser, including interactions by a user with the browser and data received by the browser. In response to detecting video data within the web page, the overlay extension transmits metadata identifying the detected video data to an overlay server. For example, the metadata includes a web page identifier and an identifier of the video data. Subsequently, the overlay extension receives overlay content selected by the overlay server based on the metadata and renders the overlay content in a video player of the browser rendering the video data. The overlay extension accounts for one or more settings of the video player when rendering the overlay content in conjunction with the video data. Example settings of the video player affecting rendering of the overlay content include: a source of the overlay content, a source of the video data, an orientation of the video player (e.g., landscape, portrait, full-size, partial-size), a type of the overlay content, a type of the video data, or other information. Additionally, the overlay extension modifies rendering of the overlay content in response to detecting changes to one or more settings of the video player or settings of the browser to dynamically adjust presentation of the overlay content in the video player to minimize an amount of the video data obscured by the overlay content.

The overlay server may leverage information about a user of the client device obtained from metadata to select overlay content. For example, the metadata includes history of web pages rendered by the browser that the overlay server leverages to select overlay content matching, or similar to, content in web pages previously rendered by the browser. Additionally, the metadata may identify a user of the overlay server to whom the video data was rendered. The overlay server may use stored associations between the user and one or more accounts maintained by one or more third party systems to select overlay content for the user, allowing the overlay server to leverage information that one or more third party systems maintain for the user or for the video data to select overlay content for rendering in conjunction with the video data. Leveraging such information maintained by one or more third party systems that the user has authorized the overlay server to access enables the overlay server to provide more personalized overlay content to a particular user.

Similarly, the overlay server may receive a description of an interaction by the user with overlay content from the overlay extension. In response to receiving the description, the overlay server may perform one or more actions. For example, the overlay server transmits a request to a third party system associated with the overlay content with which the user interacted to perform an action for the user. As an example, in response to the description of the interaction with overlay content identifying overlay content corresponding to a product offered by a third party system, the overlay system transmits an instruction to the third party system identifying the product, identifying the item, and requesting the third party system include the item in an order for the user. In another example, in response to the description of the interaction with overlay content identifying overlay content corresponding to a product offered by a third party system, the overlay system transmits an instruction to the third party system identifying the product, identifying the item, and including a bid amount for the item obtained from the interaction with the overlay content. This simplifies performance of various actions by the user by allowing the user to perform one or more actions through interaction with the overlay content rather than separate interactions with a third party system relevant to the overlay content.

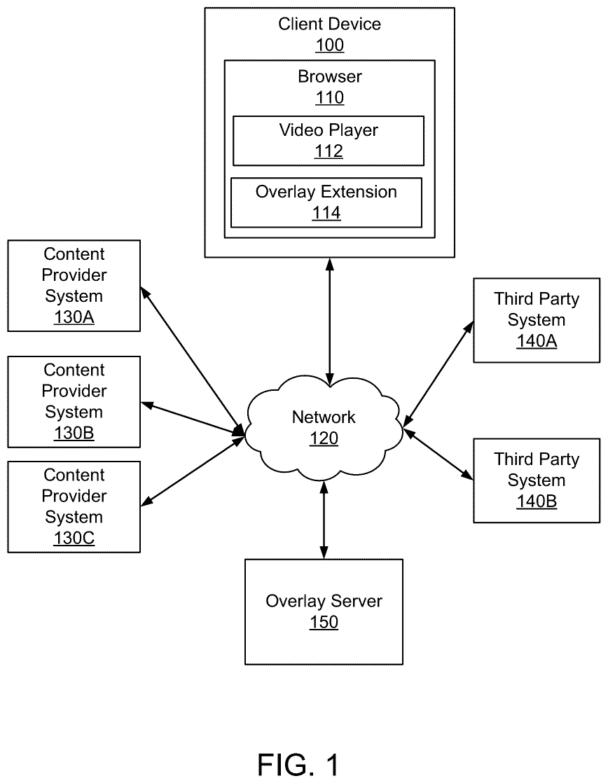

FIG. 1 illustrates an example system environment for a client device 100 to render overlay content on video data from a content provider system 130, in accordance with one or more embodiments. The system environment illustrated in FIG. 1 includes a client device 100, a network 120, one or more content provider systems 130A-C (also referred to individually and collectively using reference number 130), one or more third party systems 140A, 140B (also referred to individually and collectively using reference number 140), and an overlay server 150. Alternative embodiments may include more, fewer, or different components from those illustrated in FIG. 1, and the functionality of each component may be divided between the components differently than provided in the description below. Additionally, each component may perform their respective functionalities in response to a request from a human, or automatically without human intervention.

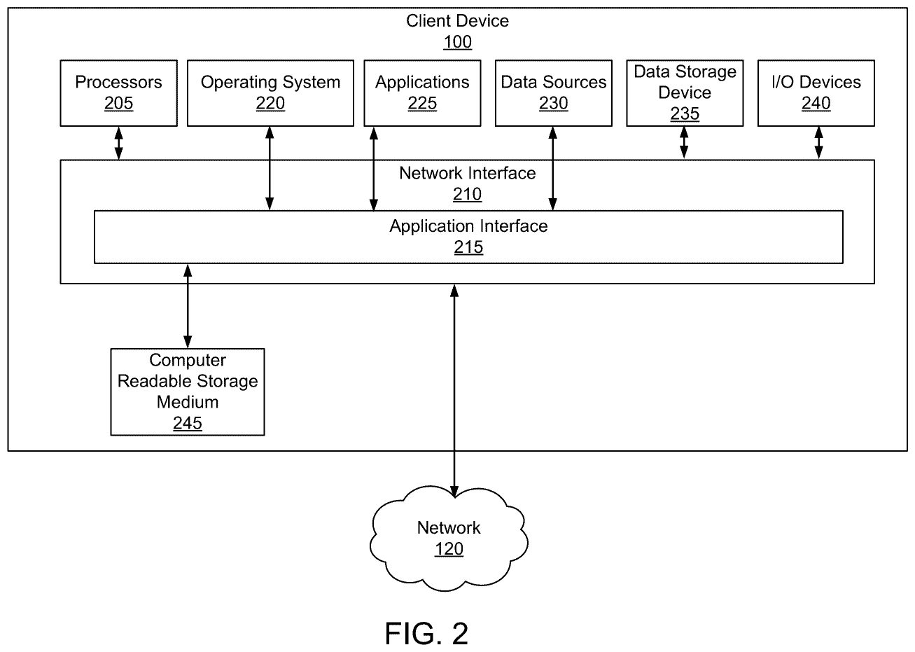

While FIG. 1 shows a single client device 100 for purposes of illustration, any number of client devices 100 may be included in the system environment. Thus, there may be more than one client device 100 in various embodiments. The client device 100 is a device through which a user may interact with one or more content provider systems 130, with one or more third party systems 140, with one or more other client devices 100, or with one or more other devices. The client device 100 may be a personal computing device or a mobile computing device. Examples of the client device 100 include a smartphone, a tablet, a laptop computer, or a desktop computer. The client device 100 includes one or more input devices configured to receive input from a user. Example input devices include: a touchscreen, a keyboard, a mouse, a microphone, an image capture device, or other devices capable of receiving interaction from a user. Additionally, the client device 100 includes one or more output devices configured to display data, such as content to a user. For example, an output device comprises a display device configured to display video data or image data. An example client device 100 is further described below in conjunction with FIG. 2.

In the example shown by FIG. 1, the client device 100 executes a browser 110. The browser 110 obtains content from one or more content provider systems 130 or third party systems 140 via the network 120 and presents the obtained content to a user. For example, the browser 110 obtains one or more web pages from a content provider system 130 or from a third party system 140 and displays content from the web page via a display device of the client device 100. While FIG. 1 shows the client device 100 including a browser 110 for obtaining content from one or more content provider systems 130 or from one or more third party systems 140, in other embodiments, the client device 100 executes one or more applications to obtain content from one or more content provider systems 130 or from one or more third party systems 140. For example, the client device 100 executes an application associated with a content provider system 130 to obtain and to present content from the content provider system 130.

One or more web pages, or other content, received by the browser 110 via the network 120 include video data. In various embodiments, the browser 110 presents the video data through a video player 112. The video player 112 retrieves video data identified in a web page from a source location (e.g., a server) identified in the web page. Subsequently, the video player 112 decodes the received video data into frames and renders the frames for display by the client device 100. For example, the browser 110 obtains a web page from a content provider system 130 including video data, and the video player 112 retrieves and renders the video data in a portion of the browser 110. Examples of video data rendered by the video player 112 include video of a sporting event, video of a creator event, video of scripted content, video of unscripted content, or video of one or more other types of events. In some embodiments, a creator event comprises one or more games or activities of a creator's choosing.

One or more settings of the video player 112 may be specified by the web page retrieved by the browser 110 or may be specified based on one or more inputs received from the user (e.g., received via the browser 110). For example, a setting of the video player 112 specifies a resolution of video data displayed by the video player 112. Another setting of the video player 112 specifies dimensions of the video player 112 within the browser 110. Other settings may specify different attributes or functionality of the video player 112.

While the video player 112 renders video data, or other content, from a content provider system 130, a third party system 140 or the overlay server 150 may maintain overlay content relevant to the video data from the content provider system 130. Displaying the overlay content in conjunction with the video data from the content provider system 130 increases a likelihood of a user of the client device 100 interacting with the overlay content or viewing the video data. As further described below, the overlay server 150 allows the video player 112 to render video data from a content provider system 130, while rendering overlay content from a different system, such as a third party system 140 or the overlay server 150, in conjunction with the video data. This increases a variety of content that the browser 110 may display to a user at one time, by enabling video data and concurrently presented overlay data to be obtained from disparate sources. As different content provider systems 130 may have different limitations or restrictions on overlay content or enforce different formatting requirements on overlay content presented in conjunction with video data, the overlay server 150 simplifies presentation of content from different sources by the browser 110.

To present video data from a content provider system 130 and overlay content from a different server than the content provider system 130, the browser 110 includes an overlay extension 114. The overlay extension 114 comprises a set of instructions that, when executed by a processor of the client device 100, provide functionality further described herein. When installed on the client device 100, the overlay extension 114 integrates into the browser 110 and captures interactions with the browser 110. For example, the overlay extension 114 captures web page identifiers, such as universal resource indicators (URIs), of web pages obtained by the browser 110. Additionally, the overlay extension 114 captures a browser history of web pages previously obtained by the browser 110. Other interactions with the browser 110 captured by the overlay extension 114 include: web services accessed by the browser 110, information about the dynamic object model (DOM) of the browser 110, one or more settings of the browser 110, modifications or customizations to the browser 110 by a user, content (e.g., video data) included in the web page currently rendered by the browser 110, selections of content within the browser 110, and modifications to one or more settings of the browser. Different or additional interactions with the browser 110 may be captured by the overlay extension 114 in various embodiments.

The overlay extension 114 analyzes the captured interactions with the browser 110. In various embodiments, the overlay extension 114 analyzes the captured interactions with the browser 110 to detect one or more specific types of content in a web page currently rendered by the browser 110. For example, the overlay extension 114 detects video data included in the web page currently rendered by the browser 110 based on analysis of captured interactions with the browser 110.

In response to detecting video data included in the web page currently rendered by the browser 110, the overlay extension 114 transmits metadata identifying the detected video data to the overlay server 150 via the network 120. In various embodiments, the metadata includes at least a subset of the interactions with the browser 110 captured by the overlay extension 114. For example, the metadata includes a browser history of web pages previously rendered by the browser 110 and one or more settings of the browser 110. As another example, the metadata includes a location of the client device 100. Various subsets of the interactions with the browser captured by the overlay extension 114 are included in the metadata describing the detected video data in different embodiments.

As further described below, the overlay server 150 selects overlay content based on the metadata received from the overlay extension 114. For example, the overlay server 150 selects overlay content based on the video data, the web page currently presented by the browser, and the browsing history. As further described below, the overlay content may include product identifiers of one or more products or services available from a third party system 140 and one or more interface elements. Alternatively or additionally, the overlay content includes one or more questions and interface elements for a user to provide answers to the questions in some embodiments. However, in different embodiments, the overlay content includes different data or interface elements.

The overlay extension 114 receives the overlay content from the overlay server 150 and obtains one or more settings of the video player 112 of the browser 110. Example settings of the video player 112 obtained by the overlay extension 114 include a size of the video player 112 within the browser 110, a resolution of video data presented by the video player 112, or other settings affecting display of video data by the video player 112. Based on the settings of the video player 112 and the overlay content, the overlay extension 114 renders one or more portions of the overlay content in one or more portions of the video player 112. The overlay extension 114 renders the one or more portions of the overlay content while the video player is rendered in the video player 112, so the overlay content is concurrently rendered with the video data. The overlay content may include images, text, animations, video, interactive buttons or other interactive interface elements, or other computer-generated content. In some embodiments, the overlay content and video data are synchronously rendered in real time, or in near real time.

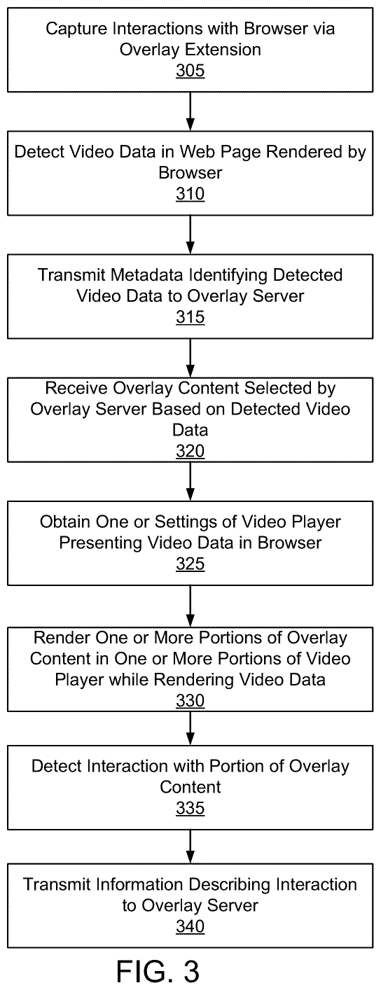

The overlay extension 114 dynamically overlays the overlay content on one or more portions of the video data as the video data plays, so different overlay content may be rendered at different times within the video data. For example, the overlay content specifies different times in the video data to render different overlay content. Alternatively or additionally, the overlay content is modified or updated based on user interactions with the browser 110 or based on other detected conditions by the overlay extension 114. In response to the overlay extension 114 detecting one or more changes to one or more settings of the video player 112 or to one or more settings of the browser 110, the overlay extension 114 modifies rendering of the overlay content in the video player 112. Accounting for one or more settings of the video player 112 when rendering the overlay content allows the overlay extension 114 to customize or to modify the overlay content as one or more settings of the video player 112 are modified maintaining appearance of the overlay content relative to the video data. For example, a change in size of the video player 112 or a change in size of a display region including the browser 110 causes the overlay extension 114 to modify the overlay content. Similarly, changing one or more of a resolution of video displayed by the video player 112, a type of the video data rendered by the video player 112, a scale of the video player 112, or other setting of the video player 112 modifies rendering of the overlay content by the overlay extension 114. Other interactions with the browser 110 or information about the browser 110 (e.g., a type of the browser 110) determine rendering of the overlay content on one or more portions of the video data. In some embodiments, the overlay extension 114 captures interactions with the browser 110 including changes to the video data displayed by the video player 112 and may modify rendering of overlay content in response to the captured interactions, as further described below in conjunction with FIG. 3. The interactions may be captured in real-time or in near real-time. This allows the overlay extension 114 to render the overlay content in one or more portions of the video player 112 that are additive and not intrusive to the user viewing the video data via the video player 112.

In some embodiments, the overlay content includes one or more conditions for when the overlay content is rendered or how to render the overlay content. The overlay extension 114 determines whether a condition is satisfied based on data from the overlay server 150 or based on one or more interactions with the browser captured by the overlay extension 114. In response to determining a condition is satisfied, the overlay extension 114 renders or modifies one or more portions of overlay content. For example, a condition specifies that a bid for a product identified by the video data or by the overlay content exceeds a bid previously received from the user; in response to receiving an indication from the overlay server 150 that the overlay server 150 received a bid exceeding the bid previously received from the user, the overlay extension 114 modifies a portion of the overlay content, or renders additional overlay content, to indicate the user has been outbid As another example, a condition specifies that user has won an auction for a product identified by the video data or by the overlay content; in response to receiving an indication from the overlay server 150 that the user has won the auction, the overlay extension 114 modifies a portion of the overlay content, or renders additional overlay content, to display a notification that the user won the auction. The conditions may be specified by the user and stored by the overlay extension 114 (or by the overlay server 150), allowing a user to customize the information included in the overlay content and when different information is displayed in the overlay content.

Additionally, the overlay extension 114 may detect an interaction with a portion of the overlay content and transmit information describing the interaction with the portion of the overlay content to the overlay server 150 via the network 120. For example, the overlay extension 114 detects selection of a specific interface element in the overlay content via the browser 110 and transmits an identifier of the overlay content with which the interaction was detected to the overlay server 150. As another example, the overlay extension 114 detects input received via an interface element of the overlay content and transmits the received input and an identifier of the interface element to the overlay server 150.

For example, an interaction by the user with overlay content is the user selecting an interface element in the overlay content to purchase a product or service identified by a portion of the overlay content or by the video data. As another example, an interaction by the user with overlay content is the user specifying a bid amount for a product or service being auctioned in the video data or in the overlay content. In another example, an interaction by the user with overlay content is the user providing an answer to a question presented via the overlay content. As an additional example, an interaction by the user with overlay content is the user selecting a wager opportunity presented by the overlay content. Further, an interaction by the user with overlay content may be the user selecting a portion of the overlay content to obtain additional information about the video data or about another portion of the overlay content. However, different or additional interactions with overlay content may be performed by a user and captured by the overlay extension 114.

In some embodiments, the overlay extension 114 is configured to integrate with one or more messaging applications executing on the client device 100. This integration allows for a more connected and interactive user experience by enhancing communication and engagement by the user of the client device 100. Moreover, in some embodiments, the overlay extension 114 is configured to prompt a messaging application executing on the client device 100 to generate messages including one or more notifications, alerts, and confirmations related to overlay content for presentation to the user. This allows users to receive additional updates or notifications about overlay content rendered by the overlay extension 114 via the one or more messaging applications to increase a likelihood of the user viewing or interacting with the overlay content. The overlay extension 114 is further described below in conjunction with FIG. 3.

While FIG. 1 describes an example where a browser 110 obtains and renders video data and overlay content, but in other embodiments, an application executing on a client device 100 obtains the video data and renders the video data. The application also obtains the overlay content from the overlay server 150, as further described above, allowing a single application to obtain video data and overlay data from different sources and concurrently render the overlay data and the video data, with the application providing the functionality of the overlay extension 114 further described herein. For example, the single application provides the functionality of the browser 110 and of the overlay extension 114 when the client device 100 is a mobile device. Alternatively, an application executing on the client device 100 obtains video data from a content provider system 130, while an overlay application executing on the client device 100 obtains overlay content from the overlay server 150, with the overlay application providing the functionality further described herein for the overlay extension 114. For example, an application and the overlay application provide functionality of the browser 110 and of the overlay extension 114, respectively, when the client device 100 is a mobile device.

The client device 100, the one or more content provider systems 130, the one or more third party systems 140, and the overlay server 150 communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of the standard layers used to describe a physical or virtual network, such as the physical layer, the data link layer, the network layer, the transport layer, the session layer, the presentation layer, and the application layer. The network 120 may include physical media for communicating data from one computing device to another computing device, such as multiprotocol label switching (MPLS) lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include BLUETOOTH® or near-field communication (NFC) technologies or protocols for local communications between computing devices. The network 120 may transmit encrypted or unencrypted data.

A content provider system 130 transmits content including video data to one or more client devices 100 via the network 120. For example, a content provider system 130 maintains one or more web pages including video data. In various embodiments, one or more content provider systems 130 are streaming servers that transmit packets comprising video data to the client device 100 via the network 120, and the client device 100 renders the video data (e.g., in the video player 112 of the browser 110) as the video data is received from the content provider system 130. A content provider system 130 may obtain live video data and transmit the live video data to the client device 100 via the network 120. For example, the content provider system 130 receives video data captured by, or obtained by, a creator client device 100 via the network 120 and transmit the video data from the creator client device 100 to the client device 100 via the network. Alternatively or additionally, the content provider system 130 maintains stored video data and retrieves stored video data in response to a request from the client device 100 via the network 120. The content provider system 130 transmits the retrieved video data to the client device 100 via the network 120.

Different content provider systems 130A, 130B, 130C may provide different content to the client device 100. For example, different content provider systems 130A, 130B, 130C transmit video data with different resolutions or different formats. Further, different content provider systems 130A, 130B, 130C maintain different content (e.g., different video data, different overlay content for presentation with video data). As another example, different content provider systems 130A, 130B, 130C includes different overlay content in one or more web pages including video data that is transmitted to the client device 100 from a content provider system 130A. For example, content provider system 130A and content provider system 130B each maintain common video data for transmission to the client device 100, but content provider system 130A and content provider system 130B each include different overlay content in corresponding web pages including the common video data transmitted to the client device 100. Further, different content provider systems 130 enforce different regulations or requirements for video data maintained by the different content provider systems 130 or for overlay content that may be provided in conjunction with video data.

A third party system 140 is a computing system separate from a content provider system 130 and from the overlay server 150. For example, the third party system 140 is in a domain different from a domain of the overlay server 150 and different from a domain of the content provider system 130. A third party system 140 maintains data for access by a client device 100 or another system (e.g., a content provider system 130, the overlay server 150). As an example, a third party system 140 maintains one or more products or services accessible via the third party system 140 that may be selected for acquisition based on an input received from the client device 100, or from another client device. The third party system 140 may identify at least a subset of the products or services accessible via the third party system 140 to the overlay server 150. Additionally, the third party system 140 may receive input or instructions from the overlay server 150 and perform one or more actions in response to the input or instructions from the overlay server 150. While FIG. 1 shows an example system environment including two third party systems 140A, 140B, in other embodiments, the system environment includes a greater number of third party systems 140 or a smaller number of third party systems 140. Different third party systems 140 maintain different data, or perform different functions, in various embodiments.

The overlay server 150 exchanges data with one or more of the client device 100, one or more content provider systems 130, and one or more third party systems 140 via the network 120. The overlay server 150 maintains one or more sets of overlay content that are each associated with a combination of metadata identifying video data and a web page identifier (e.g., a uniform resource indicator of a web page). In some embodiments, multiple sets of overlay content may be associated with a combination of metadata identifying video data and a web page identifier. Further, the overlay server 150 may associate overlay content with a combination of metadata identifying video data. For example, metadata identifying video data includes an identifier of the video data, a web page identifier, a browsing history from a browser 110 rendering the web page identifier, and one or more settings of the browser 110 rendering the web page. However, different or additional metadata may be associated with a set of overlay content in various embodiments. In response to receiving particular metadata from the overlay extension 114, the overlay server 150 selects overlay content associated with the particular metadata (or associated with metadata matching at least a threshold amount of the particular metadata received).

In various embodiments, the overlay server 150 performs one or more actions in response to receiving descriptions of various interactions with portions of overlay content from an overlay extension 114. For example, in response to receiving a description of a specific interaction, the overlay server 150 includes a particular item in an order for a user or transmits an instruction to a third party system 140 to include the particular item in the order. As another example, in response to receiving a description of a specific interaction, the overlay server 150 associates a bid amount from a user with particular item in an order for a user or transmits an instruction to a third party system 140 to associate the bid amount from the user with the particular item. In another example, in response to receiving a description of a specific interaction, the overlay server 150 transmits additional overlay content to the overlay extension 115. For an additional examples, in response to receiving a description of a specific interaction, the overlay server 150 associates data included in the description with a user identified by the description or transmits an instruction to a third party system 140 to associate data included in the description with a user identified by the description. Other actions may be performed by the overlay server 150 in response to receiving one or more descriptions of interactions with overlay content from the overlay extension 114.

The overlay server 150 includes a location module in some embodiments. The location module detemrines a location of a client device 100 from which the overlay server 150 received metadata identifying video data rendered in the video player 112 of the browser executing on the client device 100. The overlay server 150 selects overlay content for the video data based at least in part on the location of the client device 100, which may be included in the metadata received from the overlay extension 114. The overlay server 150 prevents selection of certain overlay content based on the location of the client device 100 or selects specific overlay content based on the location of the client device 100, in various embodiments.

In some embodiments, the overlay server 150 includes an authentication module that simplifies access to the overlay server 150 and to the overlay extension 114 for a user. For example, the authentication module allows a user to provide a single authentication credential (e.g., username and password) used to access multiple systems (e.g., a third party system 140, a content provider system 130) for accessing the overlay server 150 and for using the overlay extension 114. For example, the authentication module receives an authentication credential a user provides to the browser 110 and validates the user is capable of accessing the overlay server 150 and the overlay extension 114 in response to validating the authentication credential (e.g., through an authentication server). Similarly, the authentication module may allow a user to associate multiple accounts other servers maintain for the user with a user identifier or user authentication credentials for the other servers with the authentication module. Subsequently, the overlay extension 114 may access one or more accounts associated with the user by the authentication module, providing the overlay extension 114 with additional data or functionality. For example, the overlay extension 114 or the overlay server 150 may access data or content from one or more other servers accessible via one or more accounts maintained for the user and associated with the user by the authentication module.

In some embodiments, the overlay server 150 exchanges data with one or more third party systems 140. For example, the overlay server 150 receives payment information or account information for a user via the overlay extension 114 and communicates the payment information or account information to a corresponding third party system 140 on behalf of the user. This allows the user to make payments or perform other interactions with an account a third party system 140 maintains for the user via the overlay extension 114, simplifying certain interactions by the user with third party systems 140. Similarly, the overlay server 150 transmits selections of products received via the overlay extension 114 to a third party system 140 or accesses content a third party system 140 associates with the user in various embodiments.

FIG. 2 is a block diagram of one embodiment of a client device 100 on which a browser 110 including an overlay extension 114 executes. In some embodiments, the client device 100 is configured to operate or to process computer-executable instructions providing the functionality further described above in conjunction with FIG. 1. Further, in some embodiments, the client device 100 is configured to operate and/or display information within one or more graphical user interfaces (e.g., GUIs) integrated with or coupled to the client device 100.

In some embodiments, the client device 100 comprises one or more processors 205. In some embodiments, at least one processor 205 resides in, or is coupled to, one or more servers coupled to the client device 100 via the network 120. In some embodiments, the client device 100 includes a network interface 210 and an application interface 215 coupled to the least one processor 205 capable of processing at least one operating system 220. Further, in some embodiments, the network interface 210 and the application interface 215 coupled to at least one processor 205 are configured to process one or more applications 225, such as the browser 110 further described above in conjunction with FIG. 1. One or more applications 225 may include server-based software that the client device 100 obtains via the network interface 210 and the network 120 for execution by a processor 205. In some embodiments, an application 225 is configured to host at least one user account or at least one client account, or are configured to transfer data between one or more of these accounts using one or more processors 205.

The client device 100 executes various computer-implemented program steps involving data stored on one or more non-transitory computer readable storage media according to some embodiments. For example, computer-readable instructions for executing the overlay extension 114, as well as to provide other functionality described herein, are stored in computer-readable storage media within the client device 100 or stored in computer-readable storage media coupled to the client device 100 according to some embodiments. In some embodiments, the client device 100 comprises at least one computer readable storage medium 245 coupled to at least one of at least one data source 230, at least one data storage device 235, and/or at least one input/output (I/O) device 240. In some embodiments, the computer readable storage medium 245 includes any type of data storage that stores data, which is configured to thereafter be read by a computing device (such as client device 100). In some embodiments, the non-transitory computer readable storage medium 245 includes any physical or material medium used to tangibly store the desired information, steps, and/or instructions and which is configured to be accessed by the processor 205. In some embodiments, the non-transitory computer readable storage medium 245 includes hard drives, network attached storage (NAS), read-only memory, random-access memory, FLASH-based memory, CD-ROMs, CD-Rs, CD-RWs, DVDs, magnetic tapes, and/or other optical and non-optical data storage. In some embodiments, one or more applications 225 are configured to send and receive data from a database (e.g., from a computer readable storage medium 245 including one or more data sources 230 and data storage comprising a database), and data is configured to be received by an application 225 from at least one other source. In some embodiments, at least one application 225 (e.g., the browser 110) is configured to be implemented by the client device 100 to output data to at least one user via at least one graphical user interface rendered on at least one display device comprising an I/O device 240. For example, an application 225 comprises a browser 110 that receives web pages and renders the web pages for display via a display device.

In some embodiments, the one or more non-transitory computer readable storage media are distributed over the network via the network interface 210, so the non-transitory computer readable storage media are stored and executed in a distributed fashion. For example, in some embodiments, one or more components of the client device 100 are configured to send or receive data through the network 120, as further described above in conjunction with FIG. 1.

FIG. 3 illustrates a flowchart of a method for a client device rendering overlay content on video data from a content provider system presented by the client device, in accordance with one or more embodiments. Alternative embodiments may include more, fewer, or different steps from those illustrated in FIG. 3, and the steps may be performed in a different order from that illustrated in FIG. 3. These steps may be performed by the overlay extension 114, or by another component, in various embodiments. Additionally, each of these steps may be performed automatically by the overlay extension 114 without human intervention.

A browser 110 executing on a client device 100 includes an overlay extension 114, as further described above in conjunction with FIG. 1. When the browser 110 operates on the client device 100, the browser 110 obtains web pages from one or more content provider systems 130 or third party systems 140 and renders content from a web page for display in a portion of a display device of the client device 100. The overlay extension 114 captures 305 interactions with the browser 110 by the user and by one or more other systems. An interaction with the browser 110 includes web pages or other content received by the browser 110 from a content provider system 130 or from a third party system 140. Additional examples of interactions with the browser 110 include inputs the browser 110 receives from the user or inputs, or inputs the browser 110 receives one or more other applications executing on the client device 100. In various embodiments, the overlay extension 114 passively captures 305 and logs interactions with the browser 110 while the browser 110 operates on the client device 100. The overlay extension 114 may maintain a log of captured interactions in various embodiments.

For example, the overlay extension 114 captures 305 web page identifiers, such as universal resource indicators (URIs), of web pages obtained by the browser 110. Additionally, the overlay extension 114 captures 305 a browser history of web pages previously obtained by the browser 110. Other interactions with the browser 110 captured 305 by the overlay extension 114 include: web services accessed by the browser 110, information about the dynamic object model (DOM) of the browser 110, one or more settings of the browser 110, a geographic location of the client device 100, modifications or customizations to the browser 110 by a user, and content (e.g., video data) included in the web page currently rendered by the browser 110. Different or additional interactions with the browser 110 may be captured by the overlay extension 114 in various embodiments. The overlay extension 114 may transmit at least a subset of captured interactions to the overlay server 150 in various embodiments.

Based on the captured interactions, the overlay extension 114 detects 310 video data within a web page rendered by the browser 110. In various embodiments, the overlay extension 114 determines whether the web page rendered by the browser 110 identifies video data for presentation based on data in the web page. In response to detecting 310 video data within the web page rendered by the browser 110, the overlay extension transmits 315 metadata identifying the video data to the overlay server 150 via the network 120. The metadata identifying the detected video data includes a web page identifier (e.g., a URI) of the web page rendered by the browser 110 and an identifier of the video data detected 310 with in the web page. Additional information is included in the metadata in various embodiments. For example, the metadata includes at least a subset of the interactions with the browser 110 captured by the overlay extension 114. As an example, the metadata includes a browser history of web pages previously rendered by the browser 110 and a location of the client device 100 along with the web page identifier and an identifier of the video data. In some embodiments, the metadata includes one or more settings of the browser 110 or of the video player 112 included in the browser 110. Various subsets of the interactions with the browser captured 305 by the overlay extension 114 may be included in the metadata describing the detected video data in different embodiments.

In response to receiving the metadata identifying the detected video data from the overlay extension 114, the overlay server 150 selects overlay content based on the metadata received from the overlay extension 114. The overlay server 150 obtains data from one or more third party systems 140 and maintains sets of overlay content based on the obtained data. For example, a third party system 140 offers products or services for acquisition, and the overlay server 150 obtains a product catalog identifying attributes of various products or services offered by the third party system 140. Attributes of a product or service include an available inventory by the overlay server 150, pricing information, descriptive information, fulfillment information, or other information maintained by the third party system 140 for a product or service. As another example, the overlay server 150 obtains a set of questions from a third party system 140, with one or more of the questions corresponding to one or more events or subjects in video data. In some embodiments, the overlay server 150 locally generates one or more sets of overlay data, such as one or more sets of questions. For example, the overlay server 150 generates and updates one or more questions based on video data or identifies products associated with the video data. The overlay server 150 may dynamically configure and arrange portions of overlay data, such as questions or identifiers of products or services. Alternatively, a third party system 140 locally generates a set of overlay content and transmits the overlay content generated by the third party system 140 to the overlay server 150, which maintains the overlay content received from the third party system 140.

The overlay server 150 associates sets of overlay content with a combination of metadata identifying video data and a web page identifier (e.g., a uniform resource indicator of a web page). Different sets of overlay content is associated with different combinations of metadata identifying video data and a web page identifier in various embodiments. In some embodiments, multiple sets of overlay content may be associated with a combination of metadata identifying video data and a web page identifier. Further, the overlay server 150 may associate overlay content with a combination of metadata identifying video data. This allows different portions of the metadata identifying video data to affect overlay content selected by the overlay server 150. For example, metadata identifying video data includes an identifier of the video data, a web page identifier, a browsing history from a browser 110 rendering the web page identifier, and one or more settings of the browser 110 rendering the web page. However, different or additional metadata may be associated with a set of overlay content in various embodiments.

Based on the metadata identifying the detected video data received from the overlay extension 114, the overlay server 150 selects a set of overlay content. In various embodiments, the overlay server 150 selects a set of overlay content that the overlay server 150 associated with a web page identifier and metadata identifying the video data received from the overlay extension 114. Selecting the overlay content using the received metadata identifying the detected video data tailors the set of overlay content to a particular browser 110 by accounting for interactions with the browser 110 included in the metadata. For example, a history of web pages rendered by the browser 110 may be leveraged to select overlay content matching, or similar to, content in web pages previously rendered by the browser 110. As an example, the overlay server 150 selects a set of overlay content associated with a web page identifier in the received metadata, associated with an identifier of the video data in the received metadata, and associated with a browsing history that at least partially matches a browsing history included in the received metadata.

Additionally, the video data detected 310 by the overlay extension 114 may be used when selecting the set of overlay content. For example, the overlay server 150 maintains associations between identifiers of video data and sets of overlay content. Such an association may be received from a third party system 140 or from a content provider system 130 to specify a specific set of overlay content for particular video data or for a combination of web page identifier and the particular video data. Alternatively, the overlay server 150 determines an association between a set of overlay content and an identifier of video data or a combination of the identifier of video data and a web page identifier (or a set of overlay content and a combination of metadata). Further, selecting a set of overlay content based on a combination of interactions with the browser 110 captured 305 by the overlay extension 114 and with an identifier of the video data allows the overlay server 150 to select overlay content based on content of the video that is also personalized based on interactions with the browser 110, such as web pages previously rendered by the browser 110, increasing a relevance of the overlay content to a user of the browser 110.

In some embodiments, the overlay server 150 dynamically generates overlay content based on information obtained from another client device 100 or from a third party system 140 and based on the metadata. For example, the overlay server 150 obtains content items (e.g., questions, descriptions of products, etc.) from another client device 100 or from a third party system 140 and selects a set of the content items for overlay content based on characteristics of the content item and the metadata. For example, the overlay server 150 generates overlay content as content items having at least a threshold measure of similarity to the video data identified by the metadata (e.g., based on comparison of characteristics of the video data to characteristics of different content items, based on measures of similarity between embeddings for the content items and an embedding for the video data, etc.). The overlay server 150 accounts for attributes of the user of the client device 100 when generating overlay content in some embodiments. For example, the overlay server 150 leverages a browser history included in the metadata to infer preferences or likelihood of interaction with content items of a user and selects one or more content items for overlay content based on the preferences or likelihoods of interaction by the user. In various embodiments, the overlay server 150 leverages content of the video data identified by the metadata as well as characteristics of a user of the client device 100 to select overlay content. For example, the overlay server 150 selects a set of candidate content items based on the video data identified by the metadata and determines probabilities of the user interacting with each candidate content item based on attributes of the user from the metadata and characteristics of each candidate content item. Based on the determined probabilities, the overlay server 150 selects a set of candidate content items as overlay content. For example, the overlay server 150 ranks candidate content items based on their determined probabilities and selects candidate content items having at least a threshold position in the ranking as overlay content. In another embodiment, the overlay server 150 selects candidate content items having at least a threshold probability.

The overlay server 150 may account for additional information from a third party system 140 about content items obtained from a third party system 140 when selecting overlay content. For example, a third party system 140 provides content items and information about prior interactions with content items the third party system 140 received from users. The overlay server 150 selects one or more content items from the third party system 140 for overlay content based on the prior interactions from the third party system 140. For example, the third party system 140 specifies a frequency with which users previously interacted with one or more content items when presented by the third party system 140, and the overlay server 150 selects one or more content items for overlay content based on the frequencies (e.g., selects content items having at least a threshold position in a ranking based on frequencies of interaction, selects content items having at least a threshold frequency of interaction, etc.). Alternatively, the overlay server 150 determines a frequency of interaction with content items previously presented as overlay content based on information from one or more overlay extensions 114 and uses the determined frequency of interaction to select content items for overlay content, as further described above. The overlay server 150 may also account for a frequency of interaction with video data identified by the metadata when selecting overlay content. For example, the overlay server 150 selects content items having higher frequencies of interaction for video data having a higher frequency of interaction (e.g., videos data viewed by a greater number of users, etc.). In some embodiments, the overlay extension 114 selects specific overlay content received from the overlay server 150 using the information described above for the overlay server 150 to select overlay content.

Additionally, the metadata may identify a user of the overlay server 150 to whom the video data was rendered. The overlay server 150 may use stored associations between the user and one or more accounts maintained by one or more third party systems 140 to select overlay content for the user, allowing the overlay server 150 to leverage information that one or more third party systems 140 maintain for the user or for the video data to select overlay content for the video data. For example, the overlay server 150 maintains authentication information for the user to access one or more third party systems 140 in response to receiving authorization from the user. The overlay server 150 stores combinations of authentication information and third party systems 140 in association with a user identifier maintained by the overlay server 150. Received metadata includes the user identifier maintained by the overlay server 150, enabling the overlay server 150 to access one or more of the third party systems 140 on behalf of the user and to leverage information the third party system 140 maintains for the user. For example, a third party system 140 associates specific content with the user based on prior interactions by the user with the third party system 140 (e.g., prior products obtained by the user, prior products the user selected or interact with, etc.) and transmits overlay content to the overlay system 150 for the user. Leveraging such information maintained by one or more third party systems that the user has authorized the overlay server to access enables the overlay server to provide more personalized overlay content to a particular user.

As another example, the metadata includes a geographic location of the client device 100, and the overlay server 150 selects a set of overlay content based at least in part on the geographic location. For example, the overlay server 150 selects a set of overlay content associated with a web page identifier, metadata identifying the video data received from the overlay extension 114, and metadata identifying the geographic location of the client device 100. In another example, the overlay server 150 filters sets of overlay content to remove one or more sets of overlay content indicated as being unable to be presented in the geographic location identified by the metadata. The overlay server 150 subsequently selects a set of overlay content from the filtered sets of overlay content, allowing the geographic location of the client device 100 to at least partially determine the overlay content selected by the overlay server 150.

Further, in various embodiments, the overlay server 150 selects overlay content in response to receiving a specific input from a third party system 140 or from a client device 100. For example, a creator for whom video data is captured and transmitted by a content provider system 130 transmits a specific input to the overlay server 150 through a client device 100 used by the creator or by a third party system 140. The specific input identifies video data and overlay content for the video data. Subsequently, the overlay server 150 selects the overlay content identified by the specific input for metadata identifying the video data from the specific input, allowing a creator or a third party system 140 to initiate presentation of particular overlay content for video data. For example, a creator included in video data rendered by the video player 112 transmits a specific instruction to the overlay server 150 to select overlay content including an auction for or product identifiers for one or more items (e.g., items included in the video data or associated with the video data) or including one or more specific questions about the video data in response to receiving metadata from a client device 100 that identifies the video data.

For example, a set of overlay content comprises a chaser game that is a skill-based interaction involving a competition of questions that are displayed in overlay content by the overlay extension 114. The overlay server 150 selects the chaser game based on the received metadata identifying the video data. In some embodiments, the set of overlay content displays one or more questions of the chaser game before an event occurs in the video data (e.g., before a particular event begins in the video data). The overlay server 150 maintains or obtains different sets of questions for different video data, with questions of a set customized for content of particular video data, such as for a particular event shown in the video data. The selected set of overlay content may include multiple subsets of questions, with different subsets of questions corresponding to different events in the video data (or corresponding to different times in the video data), so the overlay extension 114 presents different subsets of questions based on events occurring in the video data or based on a time elapsed by the video data). Partitioning the set of overlay content into subsets of questions may be based on a type of content included in the video data, which may be identified in the metadata received from the overlay extension 114. The overlay server 150 may transmit multiple subsets of overlay data to the overlay extension 114, which locally selects which subset of overlay data to render based on the video data. Alternatively, the overlay server 150 transmits different subsets of overlay data to the overlay extension 114 at different times based on events or other content in the video data based on metadata received from the overlay extension 114 identifying the video data at different times.

In some embodiments, the overlay content includes instructions for the overlay extension 114 to display an indication of a correct or incorrect answer to a question in a portion of the overlay content, providing a user with feedback about responses to the questions. For example, the overlay extension 114 displays a specific interface element in the overlay content in response to determining an answer previously received from the user to a question presented by the overlay content was incorrect (or in response to receiving an indication from the overlay server 150 that the answer previously received from the user to the question presented by the overlay content was incorrect). In some embodiments, the overlay content prevents a user from answering all questions of the set at the same time. Further, the set of questions may be dynamically modified based on one or more events detected within the video data and identified by the overlay extension 114 or by the overlay server 150. For example, the overlay server 150 (or the overlay extension 114) increases question difficulty over time, presents questions that are specific or nuanced to events occurring in the video data (e.g., specific events, specific patterns of movement, etc.), presents questions including trivia that may or may not be related to events in the video data, or performs other actions to modify questions presented by the overlay content over time. Additionally, the set of overlay content transmitted to the overlay extension 114 includes rules for users to answer questions in the overlay content, timing information for answering questions in the overlay content, as well as other information used by the overlay extension 114 to present the overlay content and manage interaction by users with the overlay content.

In various embodiments, such a chaser game comprising overlay content including one or more expert users, called “chasers.” A chaser may be a skilled user with experience or familiarity with one or more events presented by the video data. In some embodiments, a skilled user is a user having a percentage of winning the chaser game equaling or exceeding a threshold percentage. In response to the overlay server 150 selecting a set of overlay content comprising a chaser game, the overlay content displays questions to multiple users who are viewing the video data identified by the received metadata, with the overlay content presenting a common set of questions to chasers and to other users. The overlay server 150 receives answers to questions presented via overlay content from chasers and users and generates a score for the users and for the chasers. The overlay server 150 may reduce a score for a chaser by a handicap in some embodiments. In some embodiments, a user is “ahead” of a chaser when the user has a score greater than the chaser's score.

The set of overlay content may display one or more answers to the overlay server 150 received from one or more chasers to at least a portion of the other users (e.g., users accessing the video data via a particular web page, users accessing the video data from a client device 100 having a particular geographic location) before the overlay server 150 generates scores for users based on answers to the questions received from the users. For example, the overlay server 150 transmits overlay content to the overlay extension 114 including answers received from one or more chasers to other users after an event in the video data concludes, but before the overlay server 150 evaluates answers from the users. The overlay server 150 and the overlay extension 114 communicate with each other to manage delays in different client devices 100 receiving the video data to prevent different client devices from displaying overlay content before other client devices 100 that received the overlay content render the overlay content when overlay content includes one or more questions relating to portions of the video data.

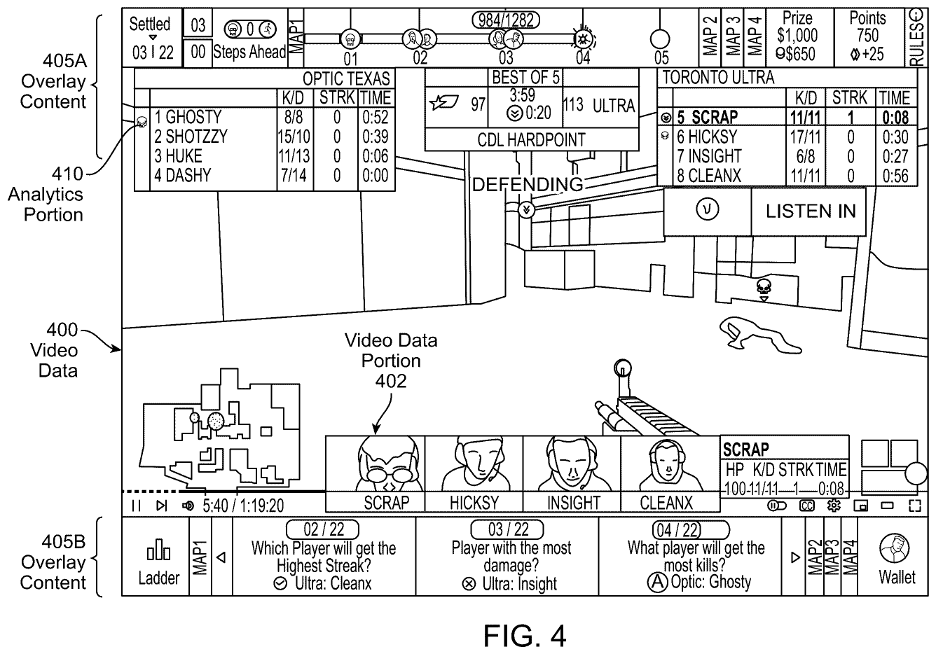

In some embodiments, the overlay server 150 receives answers to the questions presented as overlay content from various users via the overlay extension 114 and determines a winner of the chaser game as a user having a score based on their answers that was greater than a score for one or more chasers for a maximum amount of time. If multiple users had scores greater than a score for one or more chasers for a common amount of time, the overlay server 150 identifies each of the multiple users as winners. The overlay server 150 may obtain compensation from one or more users participating in the chase game in some embodiments. FIGS. 4-8 illustrate examples of overlay content for presentation as part of a chaser game.

As another example, overlay content includes information about one or more products or services. The products or services may be included in the video data or may be associated with the video data by the overlay server 150 or by a third party system 140. In various embodiments, overlay content includes product identifiers for various products or services, with a product identifier including one or more attributes of the product. A product identifier includes one or more interface elements in various embodiments. An interface element may retrieve additional information about a product when selected by a user in some embodiments. Alternatively, an interface element transmits an instruction to include the product corresponding to the product identifier in an order for the user to a third party system 140 or to the overlay server 150. In another example, an interface element transmits a bid amount for the product corresponding to the product identifier in an order for the user to a third party system 140 or to the overlay server 150.

In some embodiments, the overlay extension applies one or more machine learning models to the video data to identify one or more products in the video data. Subsequently, the overlay extension 114 selects a portion of overlay content received from the overlay server 150 corresponding to the identified one or more products for rendering, as further described below. This allows the overlay extension 114 to dynamically select portions of overlay content to render based on content of the video data.

The overlay extension 114 receives 320 the overlay content selected by the overlay server 150 and obtains 325 one or more settings of the video player 112 of the browser 110. Example settings of the video player 112 obtained 325 by the overlay extension 114 include a size of the video player 112 within the browser 110, a resolution of video data presented by the video player 112, or other settings affecting display of video data by the video player 112. Based on one or more settings of the video player 112 and the overlay content, the overlay extension 114 renders 330 one or more portions of the overlay content in one or more portions of the video player 112. The overlay extension 114 renders 330 the one or more portions of the overlay content while the video player is rendered in the video player 112. Hence, the overlay content and the video data are visible in the video player 112 in various embodiments. Alternatively, the overlay extension 114 renders 330 the overlay content proximate to the video player 112 within the browser 110. The overlay content may include images, text, animations, video, interactive buttons or other interactive interface elements, or other computer-generated content.

Accounting for one or more settings of the video player 112 when rendering 330 the overlay content allows the overlay extension 114 to customize or to modify the overlay content as one or more settings of the video player 112 are modified. For example, a change in one or more dimensions of the video player 112 or a change in one or more dimensions of a display region including the browser 110 causes the overlay extension 114 to modify the overlay content. Similarly, modifications to one or more of: a resolution of video displayed by the video player 112, a type of the video data rendered by the video player 112, a scale of the video player 112, or other setting of the video player 112 affects rendering 330 of the overlay content by the overlay extension 114. Other interactions with the browser 110 or information about the browser 110 (e.g., a type of the browser 110, a location of the client device 100) determine rendering of the overlay content on one or more portions of the video data. This allows the overlay extension 114 to render the overlay content in one or more portions of the video player 112 that are additive and not intrusive to the video data for the user. In response to the overlay extension 114 detecting one or more changes to one or more settings of the video player 112 or one or more settings of the browser 110, the overlay extension 114 modifies rendering of the overlay content in the video player 112 based on the one or more changed settings.

In various embodiments, the overlay extension 114 dynamically renders 330 one or more portions of the overlay content on one or more portions of the video data as the video player 112 renders the video data, so different overlay content may be rendered at different times within the video data. For example, the overlay content includes timing information for different portions of the overlay content, with the timing information specifying times within the video data when different portions of the overlay content is rendered 330 by the overlay extension 114. As another example, the overlay content includes associations between different portions of overlay content and events or objects in the video data; the overlay extension 114 applies one or more machine learning models to the video data to detect events or objects in the video data and renders 330 portions of the overlay content corresponding to detected events or objects in the video data. Alternatively or additionally, the overlay extension 114 modifies or updates the overlay content based on user interactions with the browser 110 or based on other detected conditions by the overlay extension 114.

In some embodiments, the overlay extension 114 captures an interaction with the browser that modifies one or more settings of the video player 112, and the overlay extension 114 modifies the overlay content based on the one or more modified settings of the video player 112. For example, the user of the client device 100 (or the client device 100) resizes the video player 112, and the overlay extension 114 modifies one or more dimensions of the overlay content and a position of the overlay content within the video player 112 so the overlay content does not obscure additional portions of the video data in the resized video player 112. As another example, a setting of the video player 112 is modified to change a resolution of video data rendered in the video player 112, so the overlay extension 114 modifies a resolution of the overlay content based on the changed resolution of the video player (e.g., modifies the resolution of the overlay content to match the changed resolution of the video data rendered in the video player 112). Similarly, modifications to one or more browser settings captured by the overlay extension 114 cause the overlay extension 114 to modify the overlay content. For example, changing dimensions of a display area (e.g., a window) in which the browser 110 is displayed affects the sizing of the video player 112, so the overlay extension 114 resizes and repositions the overlay content within the video player 112 based on the updated sizing of the video player 112. The overlay extension 114 modifies the overlay content in response to capturing modifications to one or more other settings of the video player 112 or to capturing modifications to one or more other browser settings in various embodiments.

While rendering 330 the overlay content in one or more portions of the video player 112, the overlay extension 114 detects 335 an interaction with a portion of the overlay content and transmits 340 information describing the interaction with the portion of the overlay content to the overlay server 150. For example, the overlay extension 114 detects 335 an interaction by the user with an interface element (e.g., a link, a button, a slider, etc.) included in the overlay content and transmits 340 a description of the interaction and an identifier of the interface element to the overlay server 150. Oher information describing the interaction may be transmitted 340, such as a time when the interaction was detected,

In various embodiments, the overlay server 150 performs one or more actions in response to receiving the information describing the detected interaction. For example, the overlay server 150 selects additional overlay content based on the detected interaction and transmits the additional overlay content to the overlay extension 114, which renders 330 the additional overlay content in conjunction with the video data. The additional overlay content may replace a portion of the previously rendered overlay content in the video player 112 or may be rendered 330 in addition to the previously rendered overlay content. For example, in response to the detected interaction comprising receiving an answer to a question presented by the overlay content, the overlay server 150 determines an indication whether the received answer is correct and transmits the determined indication to the overlay extension 114 for presentation via overlay content. As another example, the detected interaction is a request for information, and the overlay server 150 transmits information corresponding to the request to the overlay extension 114 for presentation as overlay content.

As another example, the overlay content rendered 330 by the overlay extension 114 includes one or more product identifiers and associated interface elements. The overlay extension 114 transmits 340 information identifying a product identifier associated with an interface element that the user selected (and identifying the interface element the user selected in some embodiments). The overlay server 150 includes the product corresponding to the identified product identifier in an order for the user in response to receiving the information identifying the product identifier and the selected interface element. As another example, the overlay server 150 associates a bid for the product corresponding to the identified product identifier in response to receiving the information identifying the product identifier and the selected interface element. The overlay server 150 may transmit the information describing the interaction with the portion of the overlay content to a third party system 140, which performs an action based on the information describing the interaction with the portion of the overlay content. For example, a third party system 140 offering the product includes the product in an order or associates a bid from the user with the product in response to receiving the information describing the interaction with the portion of the overlay content from the overlay server 150.

In other embodiments, the overlay extension 114 transmits 340 information describing the interaction with the portion of the overlay content to a third party system 140 rather than to the overlay server 150. The overlay content includes instructions for whether to transmit 340 information describing one or more detected interactions to the overlay server 150 or to a third party system 140. The instructions may specify transmission of a set of interactions or interactions with a set of portions of overlay content to a third party system 140 identified by the instructions and specify transmission of an alternative set of interactions or interactions with an alternative set of portions of overlay content to the overlay server 150. This allows the overlay extension 114 to transmit 340 information describing detected interactions with one or more portions of the overlay content to the overlay server 150 or to a third party system 140.

FIG. 4 illustrates an example interface including overlay content rendered over video data in a video player of a browser. As further described above in conjunction with FIGS. 1 and 3, a browser 110 executing on a client device 100 renders video data 400 from a content provider system 130 in a video player 112. An overlay extension 114 executing in the browser 110 obtains overlay content 405A, 405B (also referred to individually and collectively using reference number 405) from an overlay server 150, as further described above in conjunction with FIGS. 1 and 3. In the example of FIG. 4, the overlay content 405 displays information for an interactive game based on the content of the video data 400. The overlay content 405B in the example of FIG. 4 displays one or more predictive questions based on the video data. The overlay content 405A in the example of FIG. 4 includes an analytics portion 410 presenting statistics obtained from analysis of the video data 400 (e.g., analysis of a competitive event shown by the video data 400). As shown in FIG. 4, the overlay extension 114 is configured to position the overlay content 405 in the video player 112 to prevent the overlay content 405 from obscuring one or more portions of the video data 400. For example, the overlay extension 114 renders the overlay content 405B in a position of the video player 112 that does not obscure the video data portion 402 of the video data 400, or other portions of the video data 400.

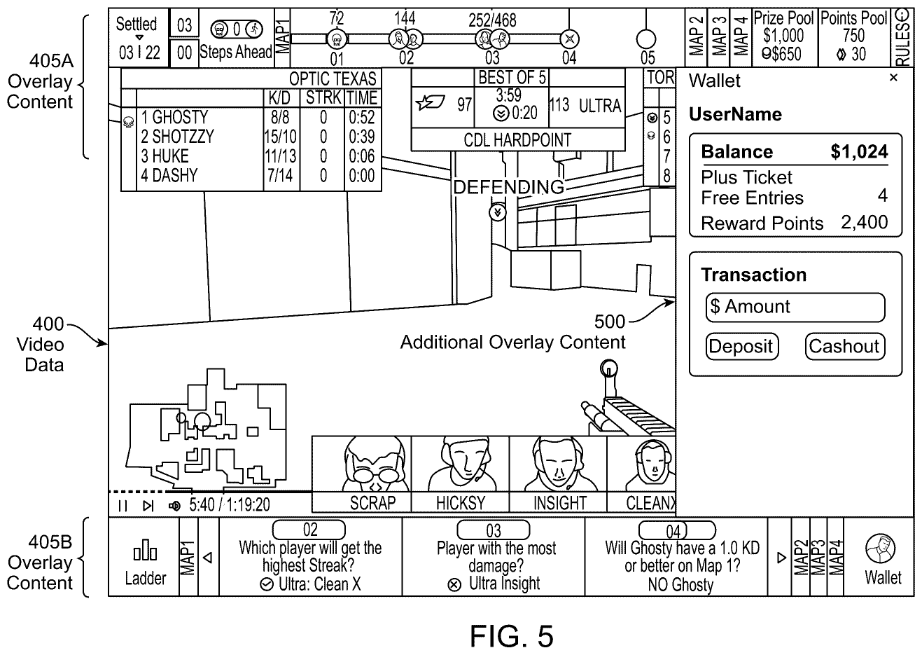

FIG. 5 illustrates an additional example interface including overlay content rendered over video data in a video player of a browser. As further described above in conjunction with FIGS. 1 and 3, a browser 110 executing on a client device 100 renders video data 400 from a content provider system 130 in a video player 112. An overlay extension 114 executing in the browser 110 obtains overlay content 405A, 405B (also referred to individually and collectively using reference number 405) from an overlay server 150, as further described above in conjunction with FIGS. 1 and 3. In the example of FIG. 5, the overlay content 405 displays information for an interactive game based on the content of the video data 400, including analytics based on the video data 400 in overlay content 405A and one or more questions based on the video data 400 in overlay content 405B. Further, in the example of FIG. 5, the overlay extension 1140 renders additional overlay content 500 in another portion of the video data 400. The additional overlay content 500 in FIG. 5 comprises a subset of information about a user viewing the video data 400 maintained by or obtained by the overlay server 150. For example, the overlay server 150 maintains a digital “wallet” that securely stores user information such as payments, accounts, passwords, and answer history and/or results. In some embodiments, the digital wallet is configured to communicate with one or more third party systems 140 to enable electronic debits and credits to a user's account associated with the overlay server 150. In some embodiments, the digital wallet can integrate with various third-party applications accessible via the browser 110 through the overlay extension 114. In some embodiments, the additional overlay content 500 is rendered in response to the overlay extension 114 receiving an interaction with a portion of overlay content 405A or with a portion of overlay content 405B. Similarly, in response to receiving an alternative interaction with the portion of overlay content 405A or the portion of overlay content 405B, the overlay extension 114 stops rendering the additional overlay content 500. In other embodiments, the overlay extension 114 stops rendering the additional overlay content 500 in response to receiving an interaction with a portion of the additional overlay content 500.

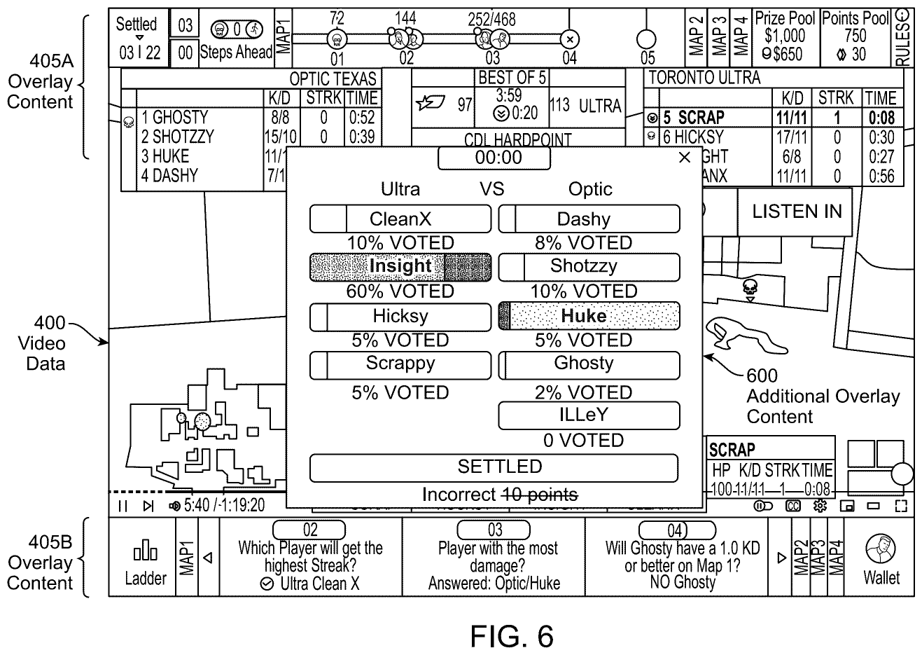

FIG. 6 illustrates an additional example interface including overlay content rendered over video data in a video player of a browser. As further described above in conjunction with FIGS. 1 and 3, a browser 110 executing on a client device 100 renders video data 400 from a content provider system 130 in a video player 112. An overlay extension 114 executing in the browser 110 obtains overlay content 405A, 405B (also referred to individually and collectively using reference number 405) from an overlay server 150, as further described above in conjunction with FIGS. 1 and 3. In the example of FIG. 6, the overlay content 405 displays information for an interactive game based on the content of the video data 400, including analytics based on the video data 400 in overlay content 405A and one or more questions based on the video data 400 in overlay content 405B. Additionally, in the example of FIG. 6, the overlay extension 114 renders additional overlay content 600 in another portion of the video player 112. The additional overlay content 600 in FIG. 6 displays data relating to a status of one or more portions of the overlay content 405A. For example, the overlay content 405A presents questions based on the video data 400, and the additional overlay content 600 displays information about answers to questions obtained by the overlay server 150 or by the overlay extension 114. In some embodiments, the additional overlay content 600 displays statistical representations of the answers the overlay server 150 or the overlay extension 114 received for questions presented in the overlay content 405B. In some embodiments, the additional overlay content 600 is rendered in response to the overlay extension 114 receiving an interaction with a portion of overlay content 405A or a portion of overlay content 405B. Similarly, in response to receiving an alternative interaction with the portion of overlay content 405A or the portion overlay content 405B, the overlay extension 114 stops rendering the additional overlay content 600. In other embodiments, the overlay extension 114 stops rendering the additional overlay content 600 in response to receiving an interaction with a portion of the additional overlay content 600.

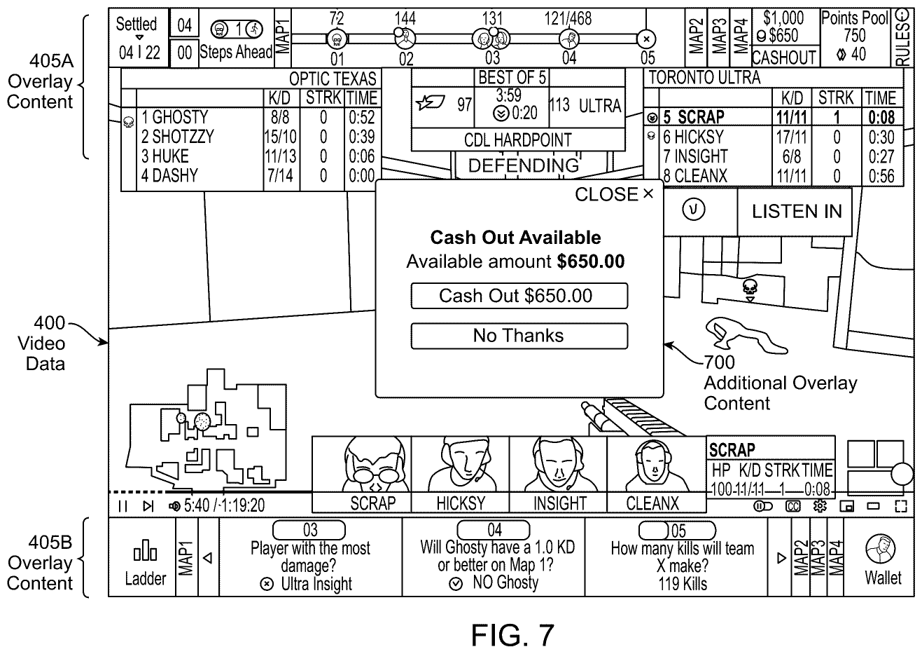

FIG. 7 illustrates an additional example interface including overlay content rendered over video data in a video player of a browser. As further described above in conjunction with FIGS. 1 and 3, a browser 110 executing on a client device 100 renders video data 400 from a content provider system 130 in a video player 112. An overlay extension 114 executing in the browser 110 obtains overlay content 405A, 405B (also referred to individually and collectively using reference number 405) from an overlay server 150, as further described above in conjunction with FIGS. 1 and 3. In the example of FIG. 7, the overlay content 405 displays information for an interactive game based on the content of the video data 400, including analytics based on the video data 400 in overlay content 405A and one or more questions based on the video data 400 in overlay content 405B. Additionally, in the example of FIG. 7, the overlay extension 114 renders additional overlay content 700 in another portion of the video data 400.

In various embodiments, the overlay content 405A or the overlay content 405B displays questions or other interactive elements that a user viewing the video data 400 may interact with by providing answers or other input via interaction with the overlay content 405A or with the overlay content 405B. Interactions with the overlay content 405A or with the overlay content 405B accumulate points for the user at the overlay server 150. The points may correspond to monetary values or some other form of compensation. The additional overlay content 700 enables a user to redeem points accumulated through the overlay server 150, displays live balance updating of points accumulated by the user, or displays a leaderboard of users based on their accumulated points. In some embodiments, the additional overlay content 700 is rendered in response to the overlay extension 114 receiving an interaction with a portion of overlay content 405A or with a portion of overlay content 405B. Alternatively, the overlay extension 114 receives an instruction to display the additional overlay content 700 in response to the overlay server 150 determining information maintained for the user satisfies one or more criteria (e.g., the overlay server 150 maintains at least a threshold amount of points for the user based on answers received from the user to questions included in the overlay content 405B). Similarly, in response to receiving an alternative interaction with the portion of overlay content 405A or the portion overlay content 405B, the overlay extension 114 stops rendering the additional overlay content 700. In other embodiments, the overlay extension 1140 stops rendering the additional overlay content 700 in response to receiving an interaction with a portion of the additional overlay content 700.

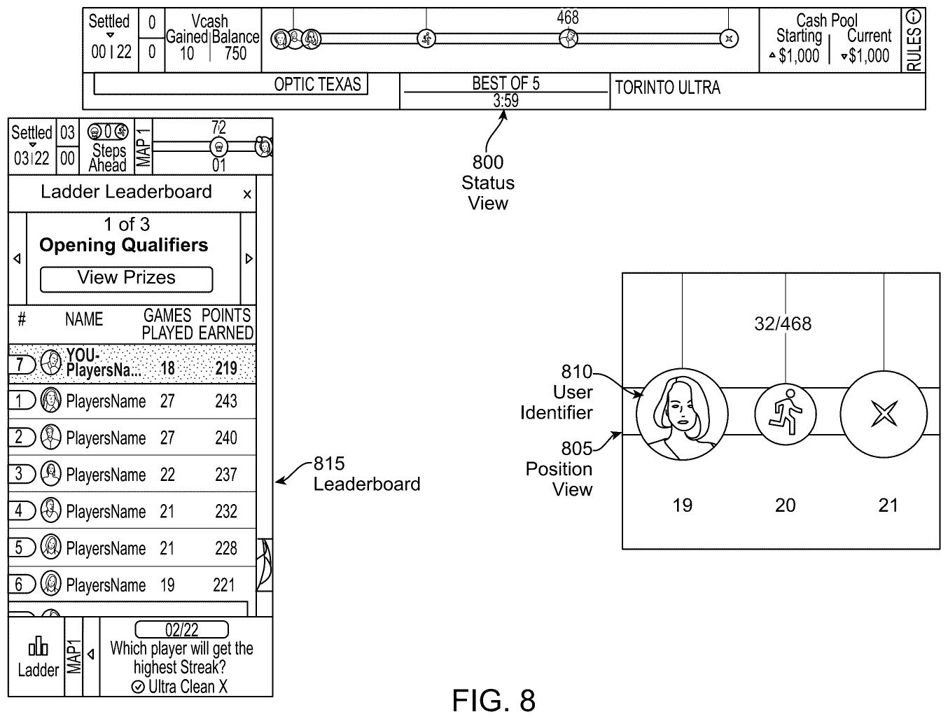

FIG. 8 illustrates examples of overlay content for a chaser game that may be overlaid on video data by an overlay extension 114. As further described above in conjunction with FIG. 3, overlay content may comprise a chaser game, with portions of overlay content including questions for a user to whom the overlay content is presented providing answers to the questions by interacting with the overlay content. One or more portions of the overlay content may identify a user's relative performance in the chaser game. For example, a status view 800 included in the overlay content depicts user identifiers of different users in a relative order based on the number of points accumulated from answering questions via the overlay content. The status view 800 includes a position view 805 in various embodiments, with the position view 805 displaying a user identifier 810, such as an avatar, of a user in a relative position to user identifiers of one or more other users. A distance between the user identifier 810 and another user identifier in the position view 805 is directly related to a difference in points maintained by the overlay server 150 for the users corresponding to the user identifiers, so a greater distance between user identifier 810 in the position view 805 indicates a larger difference between points maintained by the overlay server 150 for the corresponding users and vice versa.

Additionally or alternatively, the overlay content includes a leaderboard 815 displaying user identifiers of users in a ranking based on points associated with the users by the overlay server 150. The leaderboard 815 may identify an amount of points the overlay server 150 associated with a user in conjunction with a user identifier of the user in some embodiments. Additional or alternative information may be displayed in conjunction with user identifier in the leaderboard 815 in various embodiments. In some embodiments, the overlay server 150 allocates rewards to one or more users based on the positions of the one or more users in the leaderboard 815.

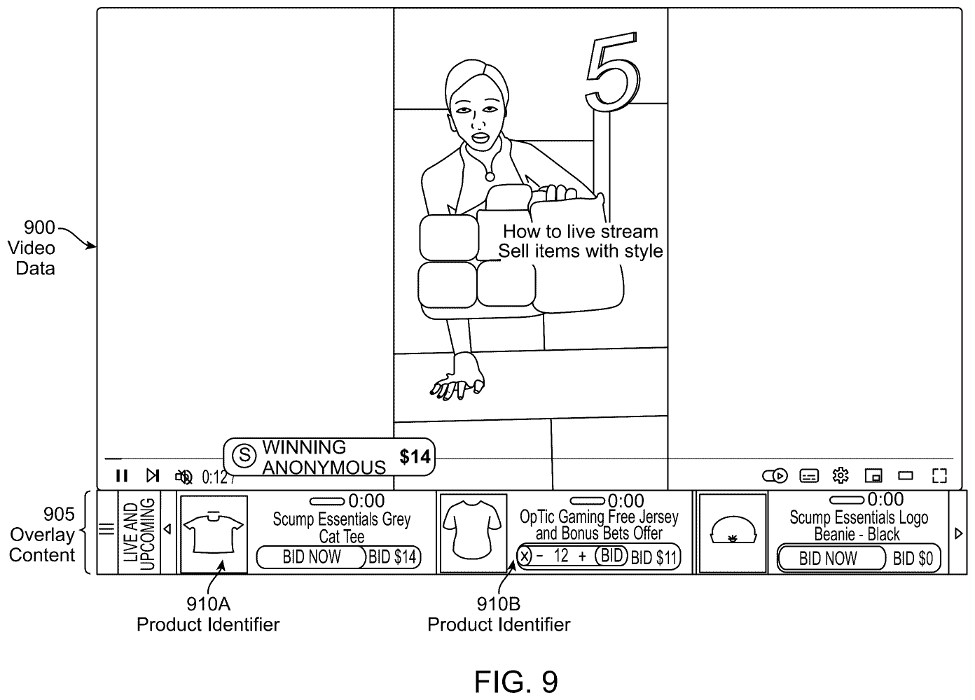

FIG. 9 illustrates an additional example interface including overlay content rendered over video data in a video player of a browser. As further described above in conjunction with FIGS. 1 and 3, a browser 110 executing on a client device 100 renders video data 900 from a content provider system 130 in a video player 112. An overlay extension 114 executing in the browser 110 obtains overlay content 905 from an overlay server 150, as further described above in conjunction with FIGS. 1 and 3. In the example of FIG. 9, the overlay content 905 displays product identifiers 915A, 915B (also referred to individually and collectively using reference number 915). A product identifier 915 may include a description of a product, as well as one or more interface elements for purchasing the product or for placing a bid for a product. For example, a product identifier 915 includes an interface element for a user to place a bid for obtaining a product identified by the product identifier 915. In other embodiments, receiving a selection of an interface element in a product identifier 915 includes a product offered by a third party system 140 in an order for the user. As further described above in conjunction with FIGS. 1 and 3, the overlay extension 114 positions the overlay content 905 in a video player 112 of a browser so the video data 900 is not obscured, or is minimally obscured, by the overlay content 905.

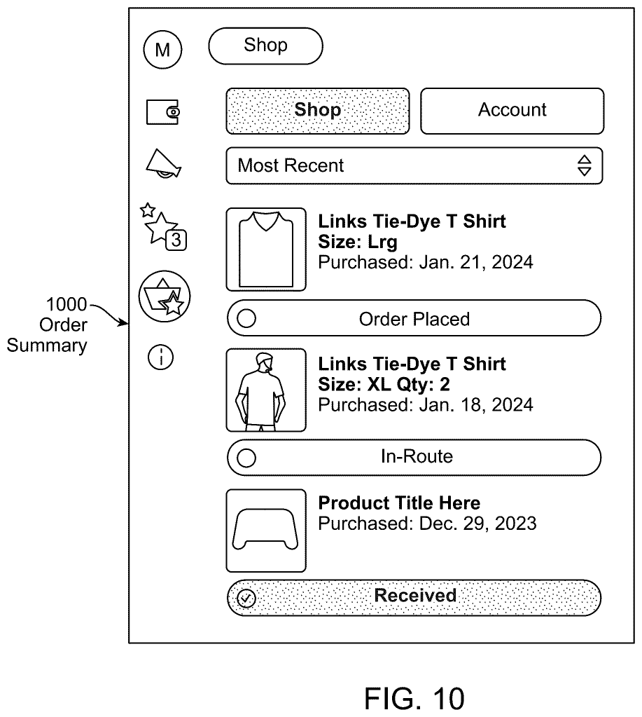

FIG. 10 is an example of an order summary capable of being presented as overlay content by the overlay extension 114. The order summary 1000 includes one or more products previously selected by a user via interaction with the overlay content rendered by the overlay extension 114 (or through interactions with a third party system 140). The overlay extension 114 displays the order summary 1000 as a portion of overlay content, and may display the order summary 1000 in response to detecting a specific interaction by the user, such as a selection of a specific element of the overlay content.

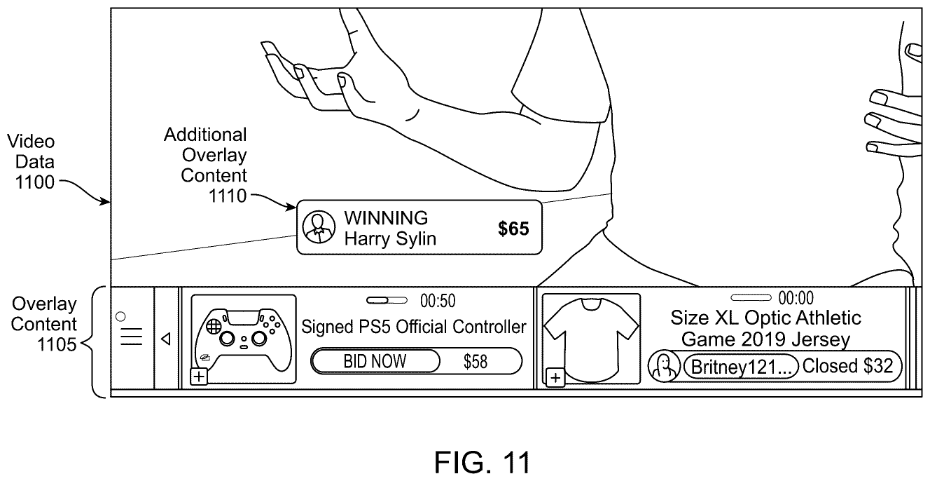

FIG. 11 illustrates an additional example interface including overlay content rendered over video data in a video player of a browser. As further described above in conjunction with FIGS. 1 and 3, a browser 110 executing on a client device 100 renders video data 1100 from a content provider system 130 in a video player 112. An overlay extension 114 executing in the browser 110 obtains overlay content 1105 from an overlay server 150, as further described above in conjunction with FIGS. 1 and 3. In the example of FIG. 11, the overlay content 1105 displays product identifiers for one or more products available from a third party system 140. Interaction with a product identifier in the overlay content 1105 includes a corresponding product in an order or places a bid for a corresponding product.

In the example of FIG. 11, the overlay extension 114 renders additional overlay content 1110 over a portion of the video data 1100. The additional overlay content 1110 in FIG. 11 presents a maximum bid received by the overlay server 150 for a product, such as for a product corresponding to a product identifier selected by the user via the overlay content 1105. In various embodiments, the overlay extension 114 displays the additional overlay content 1110 in response to detecting a selection of an interface element in the overlay content 1105. As another example, the overlay extension 114 displays the additional overlay content 1110 in response to receiving an instruction from the overlay server 150, such as in response to the overlay server 150 determining a specific condition was satisfied (e.g., an indication the overlay server 150 received an updated bid for a product).

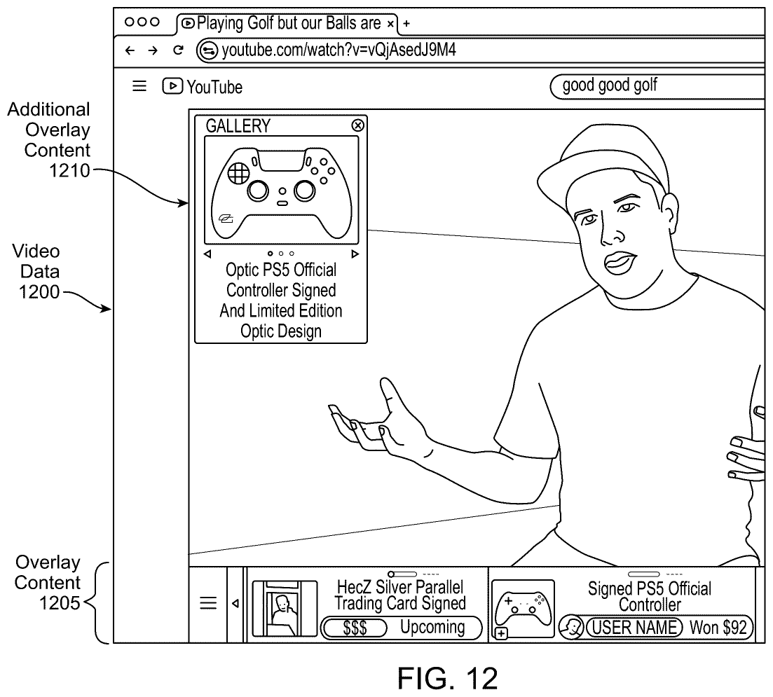

FIG. 12 illustrates an additional example interface including overlay content rendered over video data in a video player of a browser. As further described above in conjunction with FIGS. 1 and 3, a browser 110 executing on a client device 100 renders video data 1200 from a content provider system 130 in a video player 112. An overlay extension 114 executing in the browser 110 obtains overlay content 1205 from an overlay server 150, as further described above in conjunction with FIGS. 1 and 3. In the example of FIG. 12, the overlay content 1205 displays product identifiers for one or more products available from a third party system 140. Interaction with a product identifier in the overlay content 1205 includes a corresponding product in an order, places a bid for a corresponding product, or obtains information about the corresponding product.

In the example of FIG. 12, the overlay extension 114 renders additional overlay content 1210 over a portion of the video data 1200. The additional overlay content 1210 in FIG. 12 presents additional details about a product, such as a product corresponding to a product identifier selected by the user via the overlay content 1205. In various embodiments, the overlay extension 114 displays the additional overlay content 1210 response to capturing a selection of an interface element in the overlay content 1205. As another example, the overlay extension 114 displays the additional overlay content 1210 in response to receiving an instruction from the overlay server 150, which may be received in response to the overlay server 150 determining a specific condition was satisfied (e.g., a product was detected in the video data 1200).

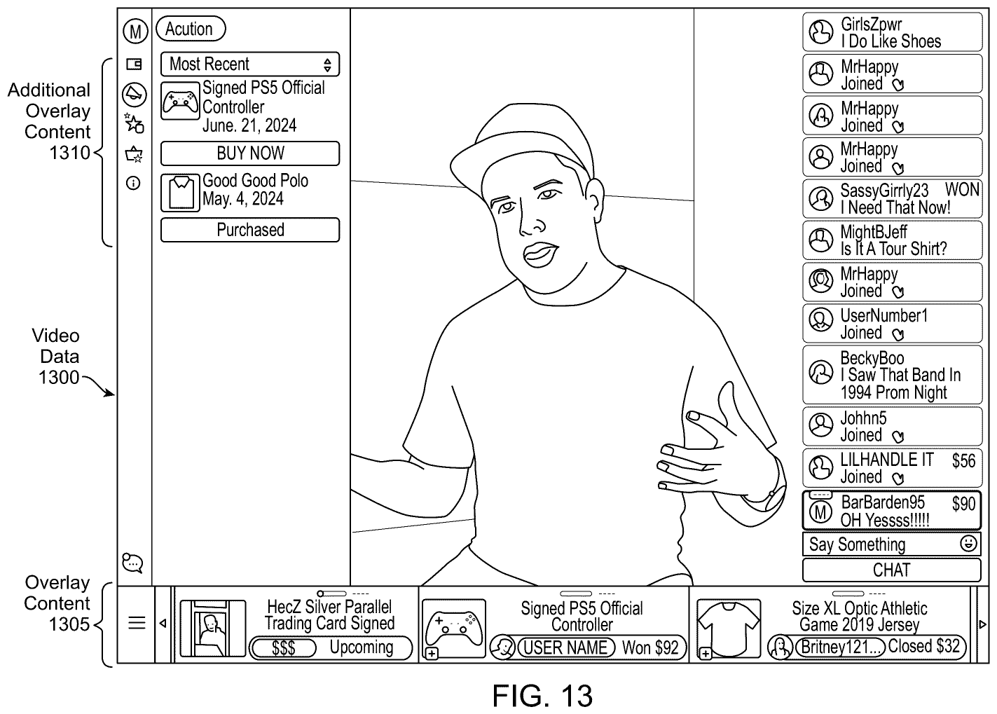

FIG. 13 illustrates an additional example interface including overlay content rendered over video data in a video player of a browser. As further described above in conjunction with FIGS. 1 and 3, a browser 110 executing on a client device 100 renders video data 1300 from a content provider system 130 in a video player 112. An overlay extension 114 executing in the browser 110 obtains overlay content 1305 from an overlay server 150, as further described above in conjunction with FIGS. 1 and 3. In the example of FIG. 13, the overlay content 1305 displays product identifiers for one or more products available from a third party system 140. Interaction with a product identifier in the overlay content 1305 includes a corresponding product in an order, places a bid for a corresponding product, or obtains additional information about the corresponding product.

In the example of FIG. 13, the overlay extension 114 renders additional overlay content 1310 over a portion of the video data 1300. The additional overlay content 1310 in FIG. 13 presents order information identifying one or more products for which the overlay server 150 received selections from the overlay extension 114 for inclusion in an order or for which a third party system 140 received selections for inclusion in an order. The overlay extension 114 displays the additional overlay content 1310 comprising the order information in response to capturing a specific interaction by the user, such as a selection of a specific element of the overlay content 1305.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
capturing, by an overlay extension of a browser executing on a client device, interactions with the browser;
detecting, by the overlay extension, video data within a web page rendered by the browser based on the captured interactions;
transmitting metadata identifying the detected video data from the overlay extension to an overlay server;
receiving overlay content from the overlay server, the overlay content selected by the overlay server based on metadata from the overlay extension;
obtaining, by the overlay extension, one or more settings of a video player within the browser presenting the video data; and
rendering, by the overlay extension, one or more portions of the overlay content in one or more portions of the video player based at least in part on the one or more settings of the video player, the overlay content rendered while the video data is rendered in the video player.

2. The method of claim 1, further comprising:
detecting, by the overlay extension, an interaction with a portion of the overlay content; and
transmitting information from the overlay extension to the overlay server describing the interaction with the portion of the overlay content.

3. The method of claim 2, further comprising:
receiving, at the overlay extension, additional overlay content from the overlay server selected by the overlay server based on the information describing the interaction with the portion of the overlay content; and
rendering, by the overlay extension, the additional overlay content in apportion of the video player in conjunction with the video data.

4. The method of claim 1, further comprising:
capturing, by the overlay extension, an interaction with the browser modifying one or more settings of the video player; and
modifying, by the overlay extension, the overlay content based on the one or more modified settings of the video player.

5. The method of claim 4, wherein the interaction with the browser modifying one or more settings of the video player comprises an interaction modifying one or more dimensions of the video player.

6. The method of claim 4, wherein the interaction with the browser modifying one or more settings of the video player comprises an interaction modifying a resolution with which the video player renders the video data.

7. The method of claim 1, wherein the overlay content comprises one or more questions based on the video data.

8. The method of claim 1, wherein the overlay content comprises product identifiers of one or more products.

9. The method of claim 8, wherein the overlay content further comprises one or more interface elements associated with each product identifier.

10. The method of claim 1, wherein the browser obtains the video data from a content provider system separate from the overlay server.

11. A non-transitory computer readable storage medium having instructions encoded thereon that, when executed by a processor, cause the processor to perform steps comprising:
capturing, by an overlay extension of a browser executing on a client device, interactions with the browser;
detecting, by the overlay extension, video data within a web page rendered by the browser based on the captured interactions;
transmitting metadata identifying the detected video data from the overlay extension to an overlay server;
receiving overlay content from the overlay server, the overlay content selected by the overlay server based on metadata from the overlay extension;
obtaining, by the overlay extension, one or more settings of a video player within the browser presenting the video data; and
rendering, by the overlay extension, one or more portions of the overlay content in one or more portions of the video player based at least in part on the one or more settings of the video player, the overlay content rendered while the video data is rendered in the video player.

12. The non-transitory computer readable storage medium of claim 11, having further instructions encoded thereon that, when executed by the processor, cause the processor to perform steps comprising:
detecting, by the overlay extension, an interaction with a portion of the overlay content; and
transmitting information from the overlay extension to the overlay server describing the interaction with the portion of the overlay content.

13. The non-transitory computer readable storage medium of claim 12, having further instructions encoded thereon that, when executed by the processor, cause the processor to perform steps comprising:
receiving, at the overlay extension, additional overlay content from the overlay server selected by the overlay server based on the information describing the interaction with the portion of the overlay content; and
rendering, by the overlay extension, the additional overlay content in apportion of the video player in conjunction with the video data.

14. The non-transitory computer readable storage medium of claim 11, having further instructions encoded thereon that, when executed by the processor, cause the processor to perform steps comprising:
capturing, by the overlay extension, an interaction with the browser modifying one or more settings of the video player; and
modifying, by the overlay extension, the overlay content based on the one or more modified settings of the video player.

15. The non-transitory computer readable storage medium of claim 14, wherein the interaction with the browser modifying one or more settings of the video player comprises an interaction modifying one or more dimensions of the video player.

16. The non-transitory computer readable storage medium of claim 14, wherein the interaction with the browser modifying one or more settings of the video player comprises an interaction modifying a resolution with which the video player renders the video data.

17. The non-transitory computer readable storage medium of claim 11, wherein the overlay content comprises one or more questions based on the video data.

18. The non-transitory computer readable storage medium of claim 11, wherein the overlay content comprises product identifiers of one or more products.

19. The non-transitory computer readable storage medium of claim 18, wherein the overlay content further comprises one or more interface elements associated with each product identifier.

20. The non-transitory computer readable storage medium of claim 14, wherein the browser obtains the video data from a content provider system separate from the overlay server.
